(19) United States
(12) Patent Application Publication
(10) Pub. No.: US 2013/0157211 A1
(43) Pub. Date: Jun. 20, 2013

(54) PROCESS AND DEVICE FOR IMPROVING THE MELTING PROCESS

(71) Applicant: Uwe Geib, Penzberg (DE)

(72) Inventor: Uwe Geib, Penzberg (DE)

(21) Appl. No.: 13/808,535

(22) PCT Filed: Jul. 6, 2011
(86) PCT No.: PCT/EP11/03361

§ 371 Date: Mar. 4, 2013

(30) Foreign Application Priority Data
Jul. 6, 2010 (DE) 10 2010 026 187.4

(51) Int. Cl. F27D 3/00

(52) U.S. Cl. CPC F27D 3/00
USPC 432/11; 432/239

(57) ABSTRACT

The invention relates to processes and apparatuses for pushing through/pushing in/turning through/turning in components/linings, as an individual component/section/subassembly for batch feeding/melting furnace/conveying path for the melt/conveying path for other emissions/transportation means for the melt, in that the pushing through/pushing in/turning through/turning in takes places in a manner controlled by means of pushing-through/pushing-in/turning-through and turning-in elements and the corresponding drives or under fully automatic control, preferably observing the maximum permissible compressive and tensile forces of the components/linings of individual components/sections/subassemblies which can be pushed through/pushed in/turned through/turned in in each case, in order to avoid joints in the respective region and to prevent inadmissibly high forces/pressures/traction/torques on the respective components/linings, during a heating operation/melting operation/cooling operation.

The invention relates to processes and devices for pushing through, pushing in, turning through, and turning in components or linings, as individual elements, sections, or complete subassemblies of a melting furnace, as well as the upstream and downstream spheres of the melting process. This begins with the preparation of the melting mixture and continues through the solidified melt, and/or the escape into the atmosphere or surrounding environment of the waste gas or other gaseous, liquid, or solid components introduced during the melting process or created during melting, i.e. without further processing steps, as well as for means of conveying the melt.

A similar process is known from the publication PCT/DE2009/000377.

### Objective:

The invention is a response to the objective of determining processes and devices by means of which, ideally, melting furnaces, their upstream and downstream spheres, and conveying means for the melt can have their service life (campaign life) extended or energy consumption reduced.

The objective of the invention is solved by the characteristics of Claims 1 through 10. The specific exemplary embodiments are described in greater detail in the subclaims.

### Description:

Definitions

The object of the invention encompasses the following spheres, beginning with the mixing of the mixture or the supplying of the raw material for the melting process, i.e. the material to be melted; the melting process itself; the further processing of the melted material, up to and including the solidified end product or the outputs stemming from the melting process and released into the atmosphere or surrounding environment, e.g. waste gases, slag, etc. or other gaseous, liquid, or solid components or products introduced during the melting process or created during melting, i.e. without further processing steps; the cooling of the outputs to atmospheric temperature and for means of conveying the melt, with “means of conveying” understood as containers by means of which the melt can, without the addition of melt during conveyance, be moved—for whatever purpose—from one place to another; the foregoing hereinafter referred to simply as melting furnace.

The invention may be applied to all types of melting furnaces, including tanks, pots, etc.; to all meltable materials, such as for melting glass, metal, minerals, etc.; and for the melting of single substances, multiple substances, melting of multiple layers, fused mixtures, etc., the foregoing hereinafter referred to simply as melting furnace and melt respectively.

The term “structural element” is used to describe the elements—generally stones—directly or indirectly surrounding the melt or the material to be melted, preferably the fireproof elements (/stones) which, e.g. in the case of a melting furnace, directly surround the melt or the furnace vessel, or in the case of several layers of structural elements arranged one behind the other, also the structural elements behind the first later. This applies also to structural elements only partially located herein.

The term “structural element” or “individual element” is used to designate individual elements, such as fireproof elements (/stones). A unit consisting of several individual elements, whether joined together or loose, is termed a “section”. The term “subassembly” is used to designate entire structures, such as the wall or the floor.

Linings, clinkers, coatings, coverings, etc., i.e. elements situated between the melt, materials to be melted, or other outputs such as waste gases, etc. and the areas/subassemblies located behind them, e.g. walls, floors, and also individual elements, etc., which keep out or counteract the pressure or other forces exerted by the melt, materials to be melted, or output products are hereinafter referred to simply as “linings”. In general, these linings transmit the pressure or forces to the externally located structural elements, but themselves have no load-bearing or counteracting function; i.e., were these linings to be removed, the pressure or forces would nonetheless be contained or counteracted. Coated materials from which e.g. the melting furnace is built are structural elements of the melting furnace. Linings are hereinafter also referred to simply as “individual elements”, “sections”, or “subassemblies”.

The term “push through/push in/turn through/turn in element” is used to denote motion elements by means of which the corresponding type of motion is realized; these motion elements are activated by driving units, such as the piston rod of a hydraulic cylinder, a chain, rollers, etc. The term “push through/push in/turn through/turn in device” is used to denote devices by means of which the corresponding type of motion can be realized, comprising at least one of the push through/push in/turn through/turn in elements and its driving unit. A “support frame” is a frame on which push through/push in/turn through/turn in devices, or at least their driving units, can be supported in order to push through/push in/turn through/turn in individual structural elements, sections, or subassemblies. The support frame can also be the support frame or at least a part of the support frame of a melting furnace, or the anchorage or a part of the anchorage of a melting furnace. Anchorages primarily serve the purpose of bracing the melting furnace to compensate for the longitudinal expansion of the different materials.

“Control” is used to mean a control which uses sensors to indicate the existence of a particular condition, or a condition which is recognized by a person and which is eliminated or changed by the action of a person, e.g. by the pushing of a button, with the elimination or changing of the condition occurring by means of actuators, e.g. hydraulic cylinders; the actuator itself may have e.g. shutoff mechanisms.

“Automatic control” is understood to mean the recognition of a particular condition by means of sensors, its evaluation in a data evaluation and control unit, and the consequent triggering of an action by actuators, e.g. hydraulic cylinders, resulting in the changing or elimination of the condition. This need not require, e.g., a fully automated feed of structural elements to be fed in, but generally comprises a control circuit between recognition of a condition and elimination of such condition.

### Representation of the Invention

The invention as characterized in Claims 1 through 10 and in the dependent subclaims, solves the problem as described below.

The pushing through/pushing in/rotating/turning in of structural elements/linings, as an individual element/section/subassembly for mixture feed/melting furnace/conveying path of the melt/conveying path of other outputs/conveying means for the melt occurs in that the pushing through/pushing in/rotating/turning in is carried out and controlled or automatically controlled by means of pushing through/pushing in/rotating/turning in elements and their corresponding driving units, preferably taking into account the maximum permissible compressive or tensile forces of the structural elements/linings capable of being pushed through/pushed in/turned through/turned in of individual elements/sections/subassemblies, in order to avoid joints in the relevant areas or prevent impermissibly high forces/pressures/tensions/momenta on the relevant structural elements/linings during the furnace heating/melting/cooling process.

### FIGURES

FIG. 1 Detail of a melting furnace, sectioned, in lateral view, with end walls (5), while pushing through a section of pushable structural elements (22), consisting of pushable individual elements (16), with a driving unit comprising a double-acting hydraulic cylinder (33), with direction of movement A of the pushable individual elements (16) indicated and the representation of a fully automated control.

FIG. 2 Detail of a melting furnace, sectioned, from above, with end walls (5), while pushing through a section of pushable structural elements (22), consisting of pushable individual elements (16), with a motion element comprising a chain (49).

FIG. 3 Detail of a melting furnace, sectioned, in lateral view, with two different types of motion of linings and two motion elements (50, 67).

FIG. 4 Detail of a melting furnace, sectioned, in lateral view, with support frame (10, 11) and two different types of driving unit (34, 36) for structural elements capable of being pushed in (23, 24, 25, 27).

FIG. 5 Perspective view of support frames (13, 14) for joined sections of the melting furnace.

FIG. 6 Detail of a melting furnace, sectioned, in lateral view, with end walls (5), depicting the act of pushing in and rotating.

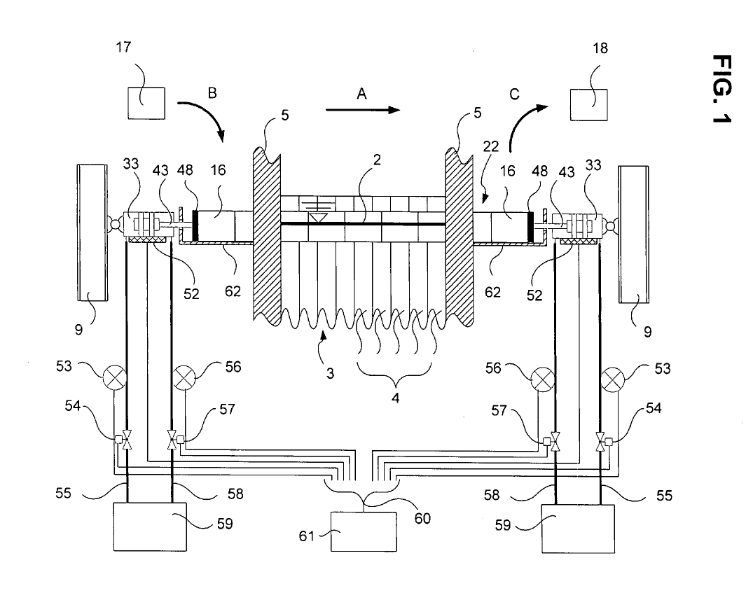

FIG. 1 shows the process according to Claim 3 and the device according to Claim 7 of a preferred embodiment, at the elevation of the surface of the melt (2), for the pushing through of a section of pushable structural elements (22), comprising pushable individual elements (16) near the rinsing edge, formed in such a way that the pushing through of pushable individual elements (16), which could also be individually pushable linings, occurs by means of double-acting hydraulic cylinders (33) in the direction of movement A of the pushable individual elements (16). In such a way that, on the feed side, Feed B of a pushable individual element to be fed in (17), a double-acting hydraulic cylinder (33) pushes the pushable individual elements (16) in the direction of movement A of the pushable individual elements (16), so that, on the output side, Output C of a pushable individual element to be removed (18), a used, pushable individual element to be removed (18) may be removed.

The double-acting hydraulic cylinders (33), as actuators or driving units preferably designed in a double-acting manner, are situated across from one another in this representation, and are controlled in a fully automated manner by means of sensors, wherein evaluation The evolution of the pressures/forces, the hydraulic line on the pressure side (55) and on the tension side (58) are transmitted from the corresponding sensors, the pressure sensor on the pressure side (53) and the pressure sensor on the tension side (56) via the control lines (60) to the data evaluation and control unit (61), and, after their evaluation in the data evaluation and control unit (61), the appropriate control commands are transmitted to the pressure control valve on the pressure side (54) and tension side (57) for the fully automated controlling of the actuators, in this case the double-acting hydraulic cylinders (33). The pressure generator (59) serves the double-acting hydraulic cylinder (33) as a pressure generator, the pressure from which is transmitted to the double-acting hydraulic cylinders (33) by means of the relevant hydraulic line on the pressure side (55) or tension side (58).

The two double-acting hydraulic cylinders (33) are ideally charged with the corresponding pressure by means of the fully automated control in such a way as to prevent joints between the pushable individual elements (16) while simultaneously not exceeding the maximum surface pressure on the individual pushable individual elements (16), in order to prevent damage to the individual pushable individual elements (16). The application of force to the section of pushable structural elements (22), which is comprised of the individual pushable individual elements (16), is carried out by means of the motion elements of piston rod and hydraulic cylinder (43) acting on the pressure plate (48), which is preferably connected to the piston rod by force or friction locking, in a fixed or variable connection, by means of, e.g., friction connections, shrinking on, screwing on, welding on, or any other technically feasible method known to a person skilled in the art, such that, when pressure is applied through the pressure-side hydraulic line (58), the motion element of the piston rod and hydraulic cylinder (43) operates on the pressure plate (48) in the direction of the corresponding support frame driving unit (9) of the relevant double-acting hydraulic cylinder (33). The support frame driving unit (9) is preferably connected with the anchorage (buckstay) of the melting furnace, or comprises a part of the anchorage, in order to counteract thermal longitudinal expansion or to achieve displacement of the melting furnace without compensatory displacement. Similarly, in the case of a connection between the melting furnace and the support frame driving unit (9), which can also logically be realized without a connection between the melting furnace and the support frame driving unit (9), a displacement of the support frame driving unit (9) or parts of the support frame driving unit (9) or merely the double-acting hydraulic cylinder (33) or pressure plate (48) is conceivable, or at least a guiding device (62) by means of further hydraulic cylinders to adjust up to a spatial displacement, in order to ensure the proper feeding into the melting furnace of the pushable individual elements to be fed in (17); a proper removal of the pushable individual elements to be removed (18) is also reasonable conceivable. It would also conceivably be possible to affix the guiding device (62) directly to the melting furnace to ensure the proper feeding in or removal of the pushable individual elements (16).

With regard to a potential jamming of pushable individual elements (16), which could for example be registered by the pressure sensor on the pressure side (53) via an increase in pressure in the pressure-side hydraulic line (55) and evaluated in the data evaluation and control unit (61), if, e.g., a higher pressure than previously used must be generated in the pressure-side hydraulic line (55) in order to accomplish the pushing through. In this case, a pushing back of the entire section of pushable structural elements (22), even if only to a very small extent, may make sense in order to resolve the jam. Such a pushing back might also be necessary e.g. in the event that at least one faulty pushable individual element (16) already inside or partially inside the melting furnace is identified, in order to prevent damage inside or to the melting furnace. In such case, the direction of movement A of the pushable individual elements (16) may be reversed and, on the side of removal C of a pushable individual element to be removed (18), the feeding in B of a pushable individual element to be fed in (17) may occur, and vice versa, at least for a limited period of time. This feeding in may also be an adding to. The insertion of new or used pushable individual elements to be fed in (17) may be carried out in such a way that new pushable individual elements (17) to be fed in after the return of the piston rod hydraulic cylinder (43), i.e. after the application of pressure in the pressure-side hydraulic line (58) by means of the pressure generator (59), with the opening of the pressure-side pressure regulator valve (57), to move the piston rod hydraulic cylinder (43) in the direction of the corresponding support frame driving unit (9) of the relevant double-acting hydraulic cylinder (33) independently, e.g. via gravity, in the guiding device. Multiple pushable individual elements (17) to be fed in may be stacked one above the other in order to ensure continuous, uncontrolled operation over an extended period. A feeding in by means of a gripper arm, a robot, or other technically reasonable means of feeding in known to one skilled in the art are also conceivable. The same applies for removal, where in the case of gravity the downward removal C of a pushable individual element (18) may fall, e.g. into a collecting bin. The guiding device (62) can also function as a means of switching out elements, e.g. by means of a displacement or rotation, for example as in the cylinder of a revolver, in the magazine of which are stored the new pushable individual elements to be fed in (17). The avoidance of joints between the pushable individual elements (16) is in most cases logical; in feeding in a new pushable individual element (17), however, care must be taken that the section of pushable structural elements (22) remains under the appropriate pressure. This may be accomplished by means of the local fixing of the most recently fed-in pushable individual element (16), e.g. by means of additional hydraulic cylinders, a clamp, a clamp in the guiding device (62) itself, or another method known to one skilled in the art, or in such a manner that each pushable individual element (16) has, e.g., a depression, drilled hole, or comparable feature, and that, for this period, the infeed can be fixed in place thereby and the pressure between the pushable individual elements (16) maintained by means of the double-acting hydraulic cylinder (33) situated at the other end of the section, thus preventing the appearance of joints between the pushable individual elements (16). The removal C of a pushable individual element (18) to be removed may be accomplished in the same way. This mechanism making use of, for example, a depression in the pushable individual element 916), which may also be a raise or similar feature, also provides the opportunity to dispense with the double-acting hydraulic cylinder (33) on the output side and always, potentially by means of pins pushed in afterward or pins which will temporarily be inserted into the depression in at least one pushable individual element (16) to achieve local fixing in order to generate the necessary counterpressure and avoid the appearance of joints. A form of connection between the individual pushable individual elements (16) is also conceivable, e.g. a dovetail, tongue and groove, or plug-in connection, etc., or with connecting elements between the individual pushable individual elements (16), in order to ensure a joint-free furnace campaign for the entire section of pushable structural elements (22). In the case of a single-acting hydraulic cylinder (34), the pressure plate (48) may also be retracted by means of the spring in the single-acting hydraulic cylinder (34), or by a spring, spring steel, or other counterforce-generating medium connected to the pressure plate (48). This is also possible in the case of the use of only one double-acting hydraulic cylinder (33) without a double-acting hydraulic cylinder (33) on the other side of the section of pushable structural elements (22). A combination of these types is also conceivable. The motion element can also be a robot or robot arm; an additional robot can hold in place the section of pushable structural elements (22) when a new pushable individual element (17) is being fed in. This is also conceivable for the removal of a pushable individual element to be removed (18). The determination that a new pushable individual element (17) is to be inserted can be made by means of a distance gauge (52), in that case e.g. a position sensor which tracks the motion of the piston of the double-acting hydraulic cylinder (33); a distance gauge (52) may be sufficient, as well as any other sensing mechanism known to one skilled in the art and capable of recognizing the displacement of the section of pushable structural elements (22) or the displacement of at least one pushable individual element (16), by means of either non-contact sensing or contact sensing, and in the simplest case by a switch mechanism, for example end switches. The same applies to the removal of a pushable individual element to be removed (18). In order to ensure that the melt (1) is properly sealed off from the surrounding environment, it is conceivable that each pushable individual element (16) be displaced from its direction of motion to another horizontal level, for example at the level of the end wall (5) before removal, i.e. in a direction of motion A of the pushable individual elements (16) in a horizontal direction, before the expulsion from the melting furnace a sinking or raising of the pushable individual element (16) occurs, so that, on the worn side of the pushable individual element (16), the wear facing the following pushable individual element (16) is pushed from their levels and thus ensures a proper seal between the melt and the surrounding environment, i.e. the sealing of the melting furnace. A displacement laterally to the direction of motion A of the pushable individual elements (16) may also occur on the same level in order to ensure such a sealing, as well as a transverse displacement or displacement or rotation of any kind. A further conceivable means of sealing would be to at least temporarily cool the pushable individual elements to be removed (18) at the location of the outflow, in order that the melt solidify at that point and form a secure seal; as needed for the displacement, the cooling could be turned off, or a reheating carried out if necessary. This procedure is to be used preferably when a periodic, rather than a continual feeding through occurs. The sealing measures can also be employed on the infeed side of the pushable individual elements to be fed in (17).

Also conceivable is the coating of the running or sliding surfaces of the individual pushable individual elements (16), or of the counterparts alone, or both, for example by means of high heat-resistant nanocoating with carbon or other methods and materials or intermediate layers known to one skilled in the art. FIG. 1 is not limited to the rinsing edge, but can also represent in this form a displacement of the palisade (27), the entire structural element of the wall, a displacement of the wall, or of the outlet, as well as other areas of the melting furnace. FIG. 1 is also not restricted to horizontal displacement, but can also represent a vertical displacement, i.e. from above to below or vice versa. In addition, an intermediate diversion or other similar structural elements transmitting motion may be interposed between the piston rod hydraulic cylinder (43) and the pressure plate (48), e.g. for thermal reasons, as well as an insulating intermediate layer, also directly between the piston rod hydraulic cylinder (43) and the pressure plate (48) or between the pressure plate (48) and the adjoining pushable individual element (16). Ideally, ceramic elements or elements with low thermal conductivity or thermal expansion coefficients similar to those of the pushable individual elements (16) are to be used, for example ones made of the same material as the pushable individual elements (16). Forming at least the piston rod hydraulic cylinder (43), which may also be called a pushrod, or even the entire double-acting hydraulic cylinder (33)—housing, piston, pushrod—of ceramic material can be advantageous.

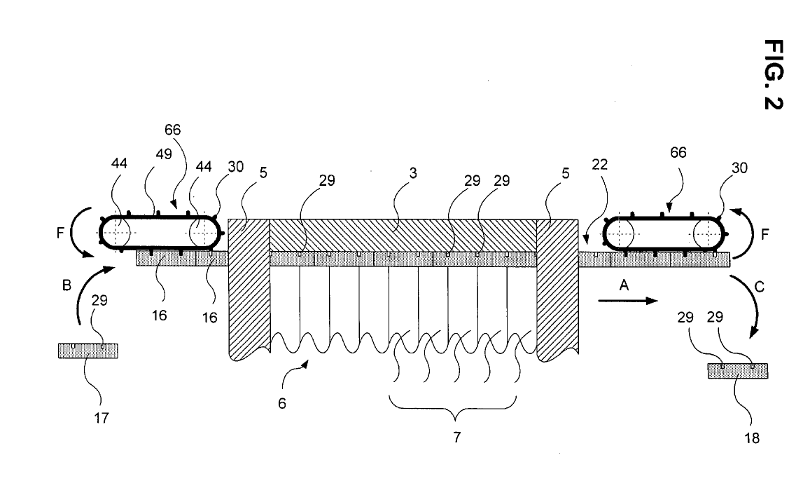

FIG. 2 shows a section of a melting furnace as seen from above, with two chain belts (66) acting jointly as a moving device and a section of pushable structural elements (22) in the form of a lining; the driving unit and other structural elements potentially transferring motion are not depicted. The pushing through of the section of pushable structural elements (22), consisting of individual pushable individual elements (16), occurs by means of a chain belt (49). The chain belt moving device (66) comprises the chain belt (49) and the two rotatable sprockets (44) with direction of motion F; only one rotatable sprocket (44) per chain belt moving device (66) can be driven. The chain belt moving device (66) on the side of the removal of pushable individual elements to be removed (18) can also be equipped, in place of a driving unit, with a brake or with a high coefficient of friction to generate counterforces to prevent the appearance of joints between the pushable individual elements (16). It may be possible to dispense entirely with an active drive unit on this side, in a similar manner as already described for FIG. 1. In order to resolve potential jamming of individual pushable individual elements (16) or the entire section of pushable structural elements (22) due to the temporary reversal of the direction of motion, direction of motion A of the pushable individual elements (16), an active driving unit for each of the chain belt moving devices (66) appears logical; at the very least, the rotatable sprockets (44) facing the melting furnace of each chain belt moving device (66) should be actively driven. It is also conceivable in the case of a form or friction-locking connection between the individual pushable individual elements (16) that only a single chain belt moving device (66) be used on one side of the melting furnace. In this case, an active pulling and pushing can occur. The driving unit of the rotatable sprockets (44) may be electric, hydraulic, pneumatic, or of any other reasonable nature; a torque-increasing gearbox or other means of reducing or increasing gear ratios known to one skilled in the art may also be employed, as well as other motion-transferring structural elements between the drive unit and the chain belt moving device (49). It seems logical to provide for the possibility of a reversal in the direction of motion of the rotatable sprockets (44). The transmission of power from the chain belt (49) to the pushable individual elements (16) located in the relevant areas of effect occurs here by means of depressions in the individual elements (29) in the individual pushable individual elements (16) and raised areas on the chain belt moving device (49). This depression in the individual element (29) and the raised area on the chain belt moving element (30) can take any form and be of any type known to one skilled in the art; form or force-fitting connections, whether temporary or requiring installation, would be feasible, as well as interlocking, interleaving, mortises, etc.

The chain belt moving device (66) may also comprise only a rotatable sprocket (44) with a corresponding means of transmitting force to the pushable individual elements (16), e.g. as between a gear wheel and gear rack; in that event, the chain belt (49) is omitted and the interlocking occurs directly on the rotatable sprocket in this case represents the motion element. In the cases of FIG. 2 described, at least one pressure roller at the level of the chain belt moving device (66) or rotatable sprocket (44) may be located at the level of the chain belt moving device (66) or rotatable sprocket (44) to press the pushable individual elements (16) against the opposing side of the chain belt moving device (66) or rotatable sprocket (44), in order to ensure that the force is transmitted from the chain belt (49) or, in the second case, from the rotatable sprocket (44). Such a pressure roller may also serve as a guiding device. Guiding devices to ensure the proper feeding of new pushable individual elements to be fed in (17) and guiding devices for the proper removal of pushable individual elements to be removed (18) appear to be advisable. Fully automatic control for the prevention of joints between the individual pushable individual elements (16) and the avoidance of excessive strains, such as surface pressure, on the individual pushable individual elements (16), as well as the adjustment of the insertion speed and direction of motion, can reasonably be carried out by means of rotary encoders (51) on at least one rotatable sprocket (44). FIG. 2 could also conceivably be used for the displacement of entire subassemblies, such as, e.g., end wall (3), etc. To this end, a chain belt moving deice (66) across the entire length, in the example with the end wall (3), across the entire end wall (3), potentially with intermediate rollers for pressing against, as in the case of a tank track; in this event, the center points of the two rotatable sprockets (44) will be situated outside the length of the structural element to be spanned. In this case, for example, the pushable individual elements (16) could be mounted on the chain belt (49) by means of various types of connection, e.g. hanging, screwing, etc., or other form or force-fitting connections generally known to one skilled in the art, and, after being pushed through, be removed automatically or partially automatically from the side now turned away from the melting furnace and new pushable individual elements (16) installed. The surface located between the two sides of the chain belt (49) may be subjected to further insulation measures, e.g. in order to prevent an employee from thermal radiation when removing the pushable individual elements to be removed (18). FIG. 2 is also not limited to horizontal displacement, but a vertical displacement can also be used, i.e. from above to below or vice versa, and a rotation in any axis is conceivable for particular areas, including also the various external surfaces of the chain belt (27) on which an installation for a replacement of pushable individual elements (16) is conceivable, in whatever form, e.g. to form in part an integral component of a wall.

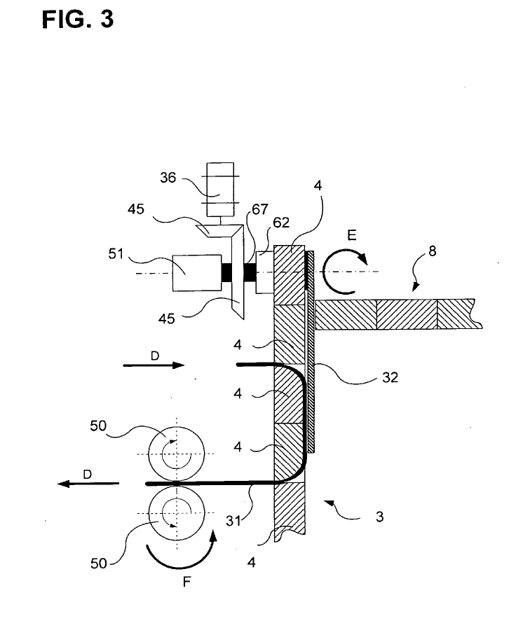

FIG. 3 depicts a section of a melting furnace in lateral view, with two different types of moving devices and driving units (36, 50), in this case for linings. The quasi-endless lining (31), with direction of motion D of the quasi-endless lining (31), is pushed variably through a part of the melting furnace, e.g. to protect it. This pushing or pulling through occurs by means of rollers as motion elements, which may have drive units of any kind. One roller (50) may serve as a non-drive pressure roller, or both rollers (50) may be driven. Each of these combinations described may only be situated on the infeed side of the quasi-endless lining (31), as represented in FIG. 3, or on both sides. An additional function for the rollers (50), as guiding devices for the endless lining (31), is also conceivable, as well as a separate guiding device for the quasi-endless lining (31). The rollers may have a smooth, nubbed, knurled, toothed, etc. form, in order to ideally place tensile forces or pressure on the quasi-endless lining (31). The quasi-endless lining (31) also has a smooth or correspondingly adapted surface. Also conceivable is a driven roller (50) having a surface permanently marking its opposite surface, such as a needle roller, pressing against the quasi-endless lining (31). A system of gear teeth on the upper side and potentially the lower side of the quasi-endless lining (31) is also conceivable, so that the rollers shown in FIG. 3 serve simply as pressure rollers, and the transmission of force for the pushing through of the quasi-endless lining occurs by means of this toothing and the corresponding toothed drive unit, perpendicular to the level of the rollers depicted (50). In this case, the motion element is a gear wheel. The rotational lining (32), direction of motion E, rotative, is fixed by means of a shaft motion element (67), which is situated in the guiding device (62). Various types of mounting for the rotational lining (32) on the shaft motion element (67) are conceivable, such as a screw fitting, a clamp, or a plug-in connector, as generally known to one skilled in the art. The bevel gear wheels (45) serve to transmit motion and also form a redirection between the actuator (36) and the shaft motion element (67), thus minimizing thermal transmission to the actuator (36). A rotary encoder (51) serves to indicate position or angle and to measure the speed of rotation. In place of the bevel gear wheels (32), any other means of transmitting motion known to one skilled in the art may be used, just as a direct mounting of the actuator (36), with and without rotary encoder, to the shaft motion element (67). The suspension and guiding device for the rotational lining (32) is situated outside the melting furnace, but could be located inside or partially inside the melting furnace. It is represented here as rotation through a vault/ceiling (8) by means of a slit.

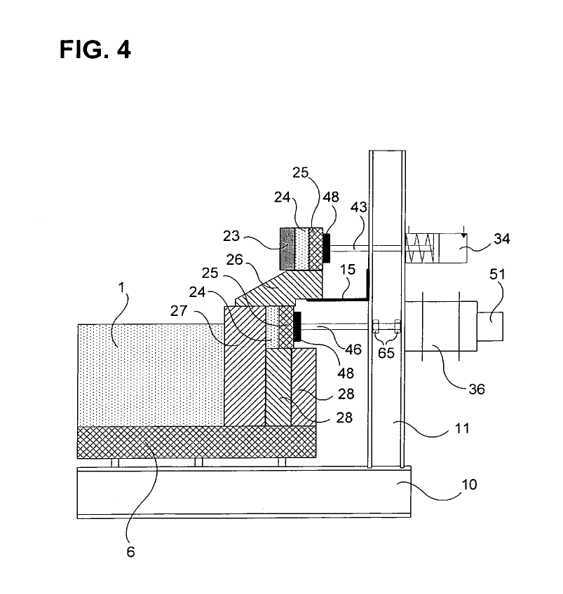

FIG. 4 depicts a section of a melting furnace with two different types of and driving units for insertion. In the course of the furnace campaign, the palisade (27) is heavily worn by corrosion. The nose brick (26) structural element located above the palisade (27) is supported by means of the nose brick-structural element suspension (15). Once the palisade (27) has suffered a certain degree of wear, the first of the follow up components, the first follow up component (24), can be fed in, thus representing an insertion or pushing in. This occurs by means of the spindle motion element (46), which can simply be a threaded rod which completes the motion via the pressure plate (48). The driving unit is the actuator (36), the movement of which by the rotary encoder (51) can determine the position of the pressure plate (48). By means of the thread guidance (65), which is connected to the support frame device (11), the rotary motion of the actuator (36) is converted to a translational movement of the spindle (46). A unit should be located between the spindle (46) and the pressure plate (48) to prevent the further transmission of the rotary motion of the spindle (46) to the pressure plate (48). After the return of the pressure plate (48) to the support frame device (11), a second follow up component (25) can be fed in. This process may be repeated multiple times, i.e. follow up component 3, then follow up component 4, etc. During the translational movement of the pressure plate (48) in the direction of the support frame device (11), the application of force to the most recently fed in follow up component—here, with regard to FIG. 4, the second follow up component (25) may be advisable in order to counteract the partial pressure of the melt. The indicated insulation (28) can also be made from the same material as the palisade (27) or a structural element fed in at a later time. A similar manner is represented by means of the representation, the structural element facing the melt (23), first follow up component (24), second follow up component (25), pressure plate (48), displacement element piston rod hydraulic cylinder (43), and the single-acting hydraulic cylinder (34). The individual follow up components, the structural element facing the melt (23), the first follow up component (24), second follow up component (25), and the other follow up components here share the same contour shape, i.e. the same dimensions, though different thicknesses or materials may be common. As the single-acting hydraulic cylinder (34) has a translational motion, the unit to compensate for the rotational motion may be dispensed with. The representation of the single-acting hydraulic cylinder (34) may also be replaced with a double-acting hydraulic cylinder (33) or a cylinder with pneumatic drive, or with a hydraulic or pneumatic telescoping cylinder. The possibilities shown in FIG. 4 can be operated with controls or fully automatic controls, i.e. under controlled conditions by means of the initiation of the insertion process by persons, e.g. after recognition that such a step should be taken as a result of measurement or a sensor-triggered notification, in simple form by pressing a button to start the process, or in operation with fully automated controls, by means of sophisticated guidance and control using sensors, such as temperature measuring, thickness measuring, or other sensors and methods known to a person skilled in the art, evaluation in a data evaluation and control unit (61), and initiation of the process to displace the motion elements (43, 46) via the corresponding driving units (34, 36). The suspension of the driving units (34, 36) may be made directly to the support frame device (11), or directly on an anchorage, or on a separate support frame which is attached to the support frame device (11) or to the anchorage. The insulation (28) can also be a follow up component, so that the palisade (27) may be inserted at a later time in its entirety, or each individual palisade (27), or so that the individual follow up components are supported on it. Elements allowing an equalization of displacements, such as between the pressure plate (48) and the motion element (43, 46), or the pressure plate (48) and the adjacent follow up component, in order to compensate for thermal longitudinal expansion or counteract displacements or lateral displacements are also advantageous. In the case of support frames containing the driving units (34, 36) and potential transmitters of motion of forces and momenta, e.g. pressure and tensile forces, such as gears, drive shafts, diverting elements, pushrods, or other transmitters of motion known to one skilled in the art, for the displacement of the motion elements (43, 46), these may also be equipped with elements capable of compensating for a displacement for compensating for possible displacements of the melting furnace or intentionally inducing such displacement in order to attain certain additional effects. These support frames may be affixed directly to the support frame of the melting furnace, or to the anchorage of the melting furnace. A floating suspension of these support frames or only the pressure elements, such as pressure plate (48), pressure roller, etc., seems advisable in this context. A measuring of the compressive forces, the pressure, or of the tensile forces, the tension, on the spindle (46) or the support frame device (11) or anchorage can also be helpful to provide further modifications for a better furnace campaign or lower energy use. From FIG. 4, a diagonal insertion or pressing in is also possible, i.e. the individual follow up components, the element facing the melt (23), the first follow up component, second follow up component, and the following third follow up component, fourth follow up component, etc., can be displaced not only in the horizontal plane, as shown in FIG. 4, but also with a positive or negative inclination from the horizontal plane, downward or upward, with—in the extreme case—a displacement from above to below, or from below to above. In the same way, a lateral displacement is also possible, i.e. obliquely into the melting furnace in the case of a horizontal displacement, with—in the extreme case—a pushing into or past the melting furnace, or a combination of the above. The depiction in FIG. 4 and its description is obviously also applicable for structural elements already layered or stacked one behind the other, so that a new follow up component can always be placed behind the element closest to the pressure plate (48).

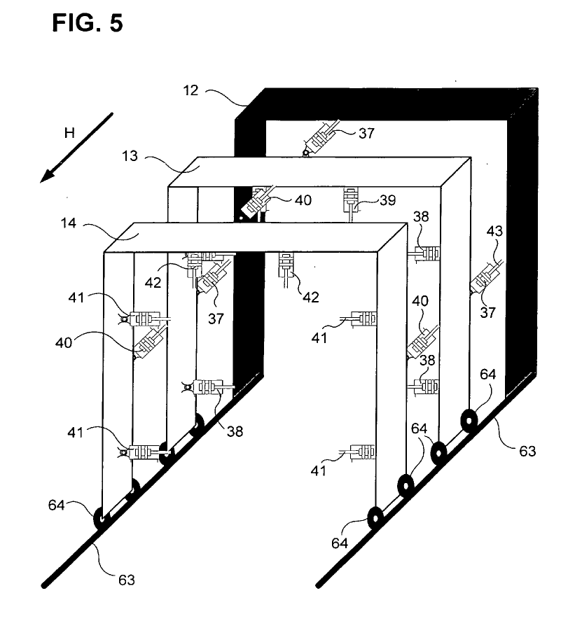

FIG. 5 depicts support frames (13, 14) for sections attached together to create subassemblies, for melting furnaces with structural elements capable of being pushed through. Such a section, comprising e.g. the connected sections of the individual partial end walls and partial ceiling, the partial sections of each which can be fixed in place or pushed in a support frame (13, 14) by means of the hydraulic cylinder (38, 39, 41, 42) and adapted to circumstances, as displaced. The stationary support frame (12) here provides the counterforce for displacing the individual support frames (13, 14) in direction of motion H of the support frames (13, 14). New support frames are inserted as needed between the stationary support frame (12) and support frame [n] (13), in this case support frame [n+1]. In this manner, all support frames are shifted away from the stationary support frame (12). The stationary support frame (12) can also be a wall or other structure comprising a counterforce for the advancement hydraulic cylinder of support frame [n] (13). The stationary support element (12) or object comprising the counterforce can also have the active element to advance the support frames (13, 14). The support frames (13, 14) have support frame wheels (64) and move on guide rails (63); this construction may be any other technically reasonable construction. An overdetermined system can be imagined for an endless furnace campaign, in a form in which two parallel rails exist on each side, so that an exchange is always ensured. The support frames (13, 14) can also be adapted to the particular furnace construction. Support frames for the driving units (38, 39, 41, 42) in the support frames (13, 14) are also conceivable, i.e. a cascading of support frames. Advancement hydraulic cylinders from support frame [n] (37) and [n−1] (40) are also situated between the individual support frames (13, 14); these adjust the spacing between the support frames (13, 14), so that joints between the sections (the partial end walls and partial ceiling, in this example) are avoided and compressive pressure between the sections remains below the maximum permissible value. The positioning hydraulic cylinder side of support frame [n] (38), position hydraulic cylinder ceiling of support frame [n] (39), and the positioning hydraulic cylinder side of support frame [n−1] (41), positioning hydraulic cylinder ceiling of support frame [n−1] (42), and the types of the positioning hydraulic cylinders of the additional support frames [n−2] to support frame [1] each position the individual elements of the corresponding partial sections using sensors and data evaluation and control unit (61) completely automatically, so that joints between the sections are avoided and compressive pressure between the sections remains below the maximum permissible value. A permanent, fully automatically controlled process of adjustment to local conditions occurs, enabling three-dimensional adaptation of every single individual element. Ideally, this can permit a never-ending furnace campaign. Starting from the stationary support frame (12), individual sections are pushed through the melting furnace, with the individual sections themselves comprising the melting furnace or parts thereof, at least for most of the time. After the completion of the furnace campaign, i.e. after having been pushed through, the individual connected sections can be disassembled without needing to interrupt the melting process. This also enables the application of additional insulation to structural elements or sections, permitting the conservation of a significant proportion of the melting energy previously required, as the exchange means that repair during the melting process (hot repair) or a cold repair are no longer needed. A counterforce or something similar, as previously described for FIG. 1, may potentially be advantageous on the opposite side of the stationary support frame 912), i.e. on the side of support frame [1]. It is also conceivable that the segments may be anchored to the corresponding support frame and pushed through the melting furnace as partial wholes in place of the individual hydraulic cylinders (38, 39, 41, 42). The same applies for the hydraulic cylinders (37, 40) between the individual support frames, which can each be anchored or connected to one another, so that, from the point comprising the counterforce, new, even ready-installed partial sections can be continually attached, and this counterpoint has the corresponding driving units for the displacement or pushing through. Similarly, in similar form, as previously described for FIG. 1. The guide rails (48) and support frame wheels (58) can be replaced with any other type known to one skilled in the art, for example by guiding devices of any type. It is also conceivable that, for example, the floor (6) should move on wheels and rails and the entire floor or segments, up to individual elements of the floor, should move or be moved and displaced in the manner described. The number of hydraulic cylinders (37, 38, 39, 40, 41, 42) is to be adjusted as circumstances require.

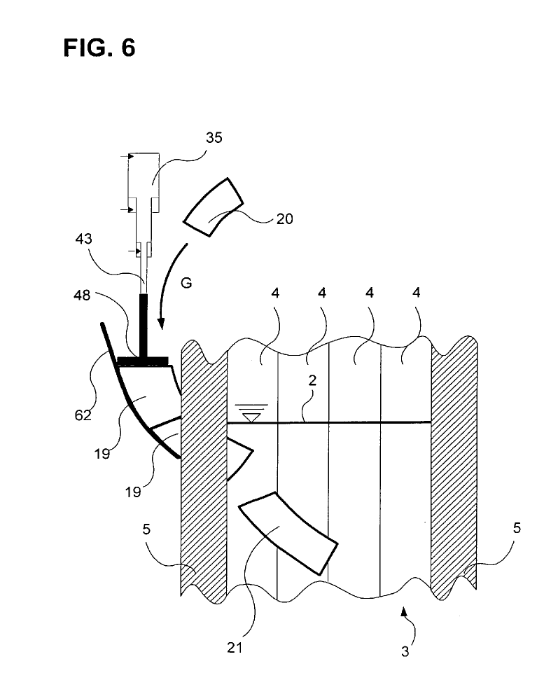

FIG. 6 shows a turning-in of rotatable individual elements (19), with a rotatable individual element to be fed in (20) and the gravity-powered individual element falling in in a rotational manner. The driving unit is comprised of a telescoping cylinder (35) of pneumatic or hydraulic type, ideally double-acting.

By means of an axial rotation of this view, as seen from above, so that the end wall (3) represents the floor, this can also be a pushing in in a horizontal plane. It is also conceivable that a rotating through could occur on the opposing end walls (5), across from the end wall (5) with guiding device (62) depicted. In the axial rotation described above, this could represent a turning through, e.g. of parts of the floor, which, in the case of outlet openings in the individual rotatable elements (19), represents a permanent exchange of outlet openings.

Furthermore, the invention makes possible the independent heating up during the pushing in, pushing through, turning in, and turning through and the cooling down in pushing through and turning through of the structural elements. A simple pulling through tensile forces is also conceivable; it would in this case be logical for the individual pushable individual elements (16) or rotatable individual elements (19) to be connected with one another by force or form-fitting means, permitting the application of a tensile force and active pulling. A turning through of parts of circular or hollow cylinders as partial components of, e.g., the wall, in a horizontal or vertical axis of rotation to the wall, is also imaginable; in this case, the motion elements are the shaft in the axis of rotation or the piston rod hydraulic cylinder (43), if the motion does not originate with the axis of rotation. It is also possible for the individual figures depicted and described, as well as for every kind of pushing in/pushing through/turning in/turning through of structural elements/sections/subassemblies, to mount or locate, interchangeably, every type of driving unit (33, 34, 35, 36, 37, 38, 39, 40, 41, 42), both hydraulic and pneumatic, with every type of motion element (43, 46, 49, 50, 67), in every imaginable combination, potentially with every type of intermediate element, in a separate support frame, as an installed unit in the support frame of the relevant area or on the anchorage of a particular area, as long as this is reasonable and technically possible.

An installation or placement in the relevant area, at least for a portion of the motion elements (43, 46, 49, 50, 67) up to their driving units (33, 34, 35, 36, 37, 38, 39, 40, 41, 42), is also conceivable.

The term structural elements can also be replaced with linings as individual element, segments, or subassembly, if reasonable and technically possible.

In the case of guide rails, guiding devices, or chain belt (49), which may also be of any other type known to one skilled in the art, for example a toothed belt, a variable guiding of the individual pushable individual elements (16) or rotatable individual elements (19) is conceivable.

Further measurement readings, such as temperature, chemical composition, chemical proportions, pressures, forces, momenta, humidity, etc. from and in the particular areas, the materials used, as well as the environment, such as waste gases, melt, mixture, atmospheric temperature and humidity, pressure transmission media (hydraulic fluid, compressed air), can also be incorporated in the evaluation to more precisely control in the motion elements (43, 46, 49, 50, 67). It is also conceivable, for example in case of emergency, that the initiation of the cooling-off process occur under automatic control in order to limit damage in the particular areas.

Data anomalies, premature wearing of parts, or the exceeding of threshold values can also be incorporated into the evaluation, as well as a fully automated evaluation of the structural elements removed, in the case of structural elements capable of being pushed or turned through, for example to control the speed of the pushing or turning through completely automatically. It is obviously clear to one skilled in the art that the data gathering may be carried out in analog or digital form, that the evaluation and transmission of the event outcomes (data) may be in, e.g., electronic, optical, or other form, and that switching as a network, in sections, or in individual operation occurs in at least one data evaluation and control unit (21); comparison values, e.g. material characteristics, can also be incorporated in the evaluation.

It is known to one skilled in the art of hydraulics/pneumatics that not all hydraulic or pneumatic cylinders must be driven by a pressure generator (59), but can be operated with the proper upstream elements in groups.

In specific cases, it may even make sense to assign every driving unit (33, 34, 35, 36, 37, 38, 39, 40, 41, 42) its own pressure generator. It is of course conceivable that every pushing in/pushing through/turning in/turning through can occur in or on every imaginable axis, axial rotation, angle, inclination, and slope, just as any number of individual elements, sections, or subassemblies can be pushed in/pushed through/turned in/turned through, in parallel, in the same direction or in different directions, overlapping, in in one direction or in opposite directions, at the same or different velocities, to the extent reasonable and technically feasible.

Similarly, statements in the individual figures do not relate exclusively to the subassemblies mentioned in each case, i.e. the individual figures can also be viewed rotated or turned from their axes, so that, e.g., a wall becomes a floor. Furthermore, a pushing in can be derived from a figure depicted and described, e.g. a pushing through, in any combination, to the extent reasonable and technically feasible.

The actuator (36) is any form of electrical driving unit, such as a stepper motor, brushless motor, linear motor, etc., operating on direct or alternating current, with or without gears or an integrated rotary encoder, and can also be a pneumatic or hydraulic type of driving unit.

The motion elements (43, 46, 49, 50, 67) can also be displacement or turning elements, or a combination thereof, to the extent reasonable and technically possible.

The guiding device (62) can also be a motion element.

All figures and descriptions can also represent, in lieu of the area of the melting furnace represented and described, any other area described in the definitions, e.g. for conveying paths for the melt.

The individual elements capable of being pushed through/turned through/pushed in/turned in can be both structural elements and linings.

The claims encompass all types of melting furnaces and meltable materials, as described in the definitions section.

### LIST OF REFERENCES

(1) Melt
(2) Melt level
(3) End wall
(4) End wall individual element
(5) End wall
(6) Floor
(7) Floor individual element
(8) Vault/ceiling
(9) Driving unit support frame
(10) Floor support frame
(11) Support frame device
(12) Stationary support frame
(13) Support frame [n]
(14) Support frame [n−1]
(15) Nose brick structural element suspension
(16) Pushable individual element
(17) Pushable individual element to be fed in
(18) Removed pushable individual element
(19) Rotatable individual element
(20) Rotatable individual element to be fed in
(21) Individual element falling in
(22) Section of pushable structural elements
(23) Structural element facing melt
(24) First follow up component
(25) Second follow up component
(26) Nose brick structural element
(27) Palisade
(28) Insulation
(29) Depressions in individual element
(30) Raised areas on chain belt
(31) Quasi-endless lining
(32) Rotational lining
(33) Double-acting hydraulic cylinder
(34) Single-acting hydraulic cylinder
(35) Telescoping cylinder
(36) Actuator
(37) Advancement hydraulic cylinder of support frame [n]
(38) Positioning hydraulic cylinder side of support frame [n]
(39) Positioning hydraulic cylinder ceiling of support frame [n]
(40) Advancement hydraulic cylinder of support frame [n−1]
(41) Positioning hydraulic cylinder side of support frame [n−1]
(42) Positioning hydraulic cylinder ceiling of support frame [n−1]
(43) Piston rod hydraulic cylinder
(44) Sprocket
(45) Bevel gear wheels
(46) Spindle
(47) Suspension
(48) Pressure plate
(49) Chain belt
(50) Rollers
(51) Rotary encoders
(52) Distance gauge
(53) Pressure-side pressure sensor
(54) Pressure-side pressure regulation valve
(55) Pressure-side hydraulic line
(56) Tension-side pressure sensor
(57) Tension-side pressure regulation valve
(58) Tension-side hydraulic line
(59) Pressure generator
(60) Control line
(61) Data evaluation and control unit
(62) Guiding device
(63) Guide rails
(64) Support frame wheels
(65) Thread guidance
(66) Chain belt motion device
(67) Shaft motion element
A. Direction of motion A of the section of pushable structural elements capable of being pushed through (22)
B. Infeed B of an individual element to be fed in (17)
C. Removal C of a removed pushable individual element (18)
D. Direction of motion D of the quasi-endless lining (31)
E. Direction of motion E of the rotational lining (32)
F. Direction of motion F of the chain belt (49)
G. Infeed G of a rotatable individual element to be fed in (20)
H. Direction of motion H of the support frames (13, 14)

1. A process for the feeding in of materials, melting furnaces, conveying of the melt, conveying of other outputs from the melting furnace and means of conveying the melt, by means of adjustable pressure elements,
characterized in that
a controlled pushing in/pushing through of individual elements (16, 19) or sections or subassemblies by means of the motion elements (43, 46, 49, 50, 67) and the corresponding driving unit (33, 34, 35, 36, 37, 38, 39, 40, 41, 42) takes place.

2. The process according to claim 1, characterized in that the controlling is fully automated.

3. The process according to claim 1, characterized in that the individual elements (16, 19) or sections or subassemblies perform a linear motion.

4. The process according to claim 1, characterized in that the individual elements (16, 19) or sections or subassemblies perform a rotational motion.

5. The process according to claim 1, characterized in that the individual elements (16, 19) or sections or subassemblies perform a variable motion.

6. A device for the feeding in of materials, melting furnaces, conveying of the melt, conveying of other outputs from the melting furnace and means of conveying the melt, by means of adjustable pressure elements,
characterized in that
the motion elements (43, 46, 49, 50, 67) permit the controlled or fully automatically controlled pushing in or pushing through of individual elements (16, 19) or sections or subassemblies by means of corresponding driving units (33, 34, 35, 36, 37, 38, 39, 40, 41, 42).

7. The device according to claim 6, characterized in that the driving units (33, 34, 35, 36, 37, 38, 39, 40, 41, 42) are hydraulic elements.

8. The device according to claim 6, characterized in that the driving units (33, 34, 35, 36, 37, 38, 39, 40, 41, 42) are pneumatic cylinder elements.

9. The device according to claim 6, characterized in that the motion elements (46, 49, 50, 67) are moved by an actuator (36).

10. The device according to claim 6, characterized in that intermediate elements transmitting motion are situated between the motion elements (46, 49, 50, 67) and the driving units (33, 34, 35, 36, 37, 38, 39, 40, 41, 42).
